(19) United States
(12) Patent Application Publication
(10) Pub. No.: US 2013/0205576 A1
(43) Pub. Date: Aug. 15, 2013

(54) Joining method and a punching, stamping rivet

(71) Applicant: Airbus Operations GmbH, (US)

(72) Inventors: Rolf Bense, Hamburg (DE); Eugen Gorr, Hamburg (DE); Joerg Jendrny, Hamburg (DE)

(73) Assignee: Airbus Operations GmbH, Hamburg (DE)

(21) Appl. No.: 13/766,095

(22) Filed: Feb. 13, 2013

Related U.S. Application Data
(60) Provisional application No. 61/598,370, filed on Feb. 14, 2012.

(30) Foreign Application Priority Data
Feb. 14, 2012 (DE) 10 2012 202 242.2

(51) Int. Cl. F16B 19/06

(52) U.S. Cl. CPC F16B 19/06
USPC 29/525.06; 411/501

(57) ABSTRACT

A method for the joining of moulded components with a punching, stamping rivet, wherein a punched hole is radially widened in at least certain sections of the moulded components that are to be punched. A punching, stamping rivet is provided which has a deforming section that has a greater external diameter than a punching section.

### CROSS-REFERENCES TO RELATED APPLICATIONS

This application claims the benefit of the U.S. Provisional Application No. 61/598,370, filed on Feb. 14, 2012, and of the German patent application No. 10 2012 202 242.2 filed on Feb. 14, 2012, the entire disclosures of which are incorporated herein by way of reference.

### BACKGROUND OF THE INVENTION

The invention concerns a method for the joining of moulded components with a punching, stamping rivet and also a punching, stamping rivet for purposes of executing such a method.

A method of known art for the joining of moulded components is so-called punching, stamping riveting with a solid rivet. Punching, stamping riveting often finds application in automotive construction and more generally in the sheet metal processing industry for thin sheets of a very wide variety of metallic materials. Suitable materials are, for example, light metals such as aluminium and magnesium, or ferrous metals such as steel. However, punching, stamping riveting also allows the joining of a metallic moulded component to a plastic-based moulded component, and thus the manufacture of hybrid connections.

Punching, stamping riveting with a solid punching, stamping rivet is based on a combined perforation and pressure forming of the moulded components, in which a rigid solid rivet generates a force and a form-fit point-to-point connection. For purposes of manufacturing the connection the moulded components are fixed on a die by means of a hold-down device, as, for example, in the patent application DE 10 2009 044 888 A1 or the patent U.S. Pat. No. 6,244,808 B1. The punching, stamping rivet is then driven by means of a rivet stamp through the moulded components and in this manner the latter are perforated. By means of the die contour and the compressive force applied via the rivet stamp and hold-down device the material of the die-side moulded component flows into a peripheral groove in the shank of the punching, stamping rivet. Here the flow of material is opposite to, or transverse to, the punching direction. At the same time the head of the punching, stamping rivet is pressed against the stamp-side moulded component, or if it is a countersunk head it is embossed into the stamp-side moulded component. The major proportion of the strength of the connection is based on the form fit, which ensues from the undercut on the punching, stamping rivet head and the filling of the shank groove of the punching, stamping rivet. A disadvantage of punching, stamping riveted connections is the fact that in comparison to bolted connections they have a relatively low vibration resistance.

### SUMMARY OF THE INVENTION

The object of the invention is to create a method for the joining of moulded components and a punching, stamping rivet, which remove the disadvantages cited above and lead to improved levels of vibration stress on a joint.

This object is achieved by means of a method with the steps of claim 1, and by means of a punching, stamping rivet with the features of claim 3.

In an inventive method for the joining of moulded components with a punching, stamping rivet, a punched hole is radially widened in at least a certain section during the punching of the moulded components.

In accordance with the invention a punched hole is introduced into the moulded components during the punching, stamping riveting process, the diameter of which is less than the diameter of the actual shank of the punching, stamping rivet, so that the punching, stamping rivet is pressed into the punched hole in a press fit with corresponding cold deformation. The cold deformation, i.e. the radial widening, causes strain hardening in the widened region of the punched hole, as a result of which a state of internal stress is generated in the vicinity of the punched hole, which has a beneficial effect on vibration resistance. After region in question of the punched hole has been widened a compressive stress remains in the latter in the peripheral direction; this prevents the generation and propagation of cracks, which leads to an enhanced vibration resistance for the joint.

The radial widening is preferably limited to regions of the punched hole that are free from a form-fit locking action, i.e. squeezing action, caused by the punching, stamping rivet. This prevents the regions of the moulded component that are to be squeezed with the punching, stamping rivet from being subjected to unnecessary strain hardening, which would make the squeezing action with the punching, stamping rivet unnecessarily more difficult. The squeezing action can be undertaken in a conventional manner with, for example, a cut-emboss die. If the squeezing action of the punching, stamping rivet is undertaken with a locking ring the punched hole can be radially widened over the whole of its axial length, and can thus be hardened by means of the deforming section.

An inventive punching, stamping rivet for the joining of moulded components, in particular for use in an inventive method, has a rivet head and at least one rivet shank, which has a punching section. In accordance with the invention the rivet shank has at least one deforming section for purposes of widening a punched hole in at least a certain section, which, as viewed in the punching direction, is arranged behind the punching section, and has a greater external diameter than the punching section.

By means of the punching, stamping rivet there takes place an automatic cold deformation of the regions of the punched hole that have been radially widened by the deforming section. By this means these punched hole regions are hardened and an enhanced vibration resistance for the joint is achieved. A separate cold deformation action, for example, by means of a mandrel driven into the punched hole so as to generate plastic deformation of the punched hole in at least certain sections is not necessary.

In one example of embodiment the at least one deforming section, as viewed in the punching direction, is arranged behind a locking section of the rivet shank. This prevents cold deformation of the punched hole by the deforming section from taking place in the region in which the locking section of the punching, stamping rivet is positioned. Thus the material that is to be squeezed with the punching, stamping rivet is not hardened and can easily be injected with the locking section. Here the material injected with the locking section is also hardened during the injecting action, so that hardening of the moulded components takes place over the whole length of the punched hole.

In an alternative example of embodiment the at least one deforming section extends from the punching section. By this means hardening of the punched hole takes place over its whole axial length by means of the deforming section. A punching, stamping rivet of this type preferably has a locking section formed from the punching section, onto which locking section a locking ring is squeezed on.

In order to be able to harden the punched hole in the immediate region of the rivet head, the at least one deforming section advantageously extends as far as the rivet head in both examples of embodiment.

In order to achieve constant strain hardening over the whole length of the at least one deforming section, the latter can have a constant external diameter, and can thus be designed in the form of a cylinder.

Alternatively the at least one deforming section can be radially widened in the direction of the rivet head, and can thus be designed in the form of a cone. By this means it is possible, for example, to configure different levels of hardening Thus the highest level of hardening could be configured in the region of the rivet head and thus in an outer region of the joint, and a lower level of hardeneing could be configured in an inner region of the joint, for example in the contact region between the two moulded components.

An example of a combination of these two geometries provides for at least one deforming section, which, as viewed in the punching direction, has a conical section, and behind this a cylindrical section. Such a combined profile is advantageous inasmuch as by this means the radial widening of the punched hole is made easier, since no step or edge is formed on the deforming section in the transition region from the previous shank section, but rather a gentle increase in the external diameter can be implemented.

In one example of embodiment the punching, stamping rivet is a multi-region rivet, with deforming sections located between its locking sections. By this means the deforming sections and the locking sections are arranged in a quasi-alternating manner in the punching direction, as a result of which cold deformation also takes place between the locking sections.

Other advantageous examples of embodiment of the invention are the subject of further subsidiary claims.

### BRIEF DESCRIPTION OF THE DRAWINGS

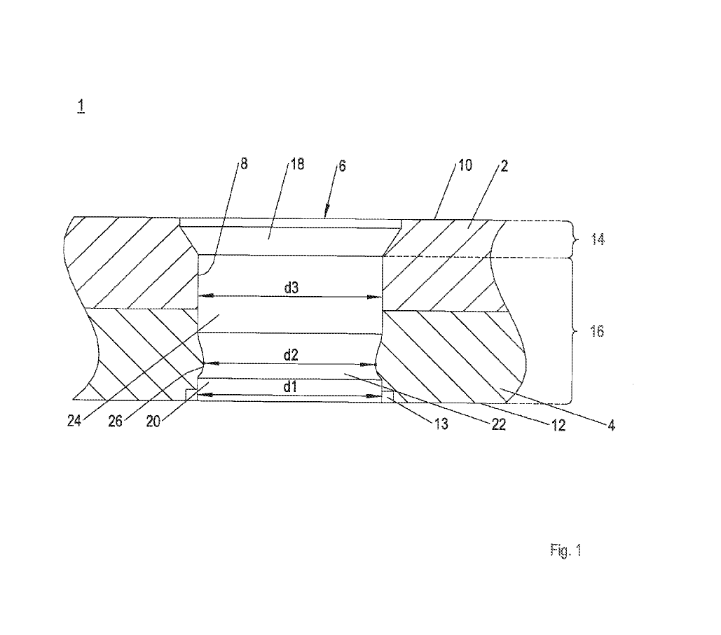

In what follows preferred examples of embodiment of the invention are explained with the aid of schematic representations. The single FIG. 1 shows a joint using an inventive punching, stamping rivet.

### DETAILED DESCRIPTION OF THE PREFERRED EMBODIMENTS

FIG. 1 shows a joint 1 between two moulded components 2, 4 formed by means of an inventive punching, stamping rivet 6. Needless to say, more than two moulded components 2, 4 can also be joined by means of the inventive punching, stamping rivet 6. The moulded components 2, 4 are designed in the form of plates in the region of the joint 1 and consist in each case of a material that can be cold formed, such as aluminium, magnesium, steel, or an appropriate metal alloy. The punching, stamping rivet 6 is fully accommodated in a punched hole 8 that it has formed, and terminates in the entry region flush with a surface 10 of what is, in accordance with the representation in FIG. 1, the upper moulded component 2. In the exit region of the punched hole 8, i.e. in the region of a surface 12 of what is, in accordance with the representation in FIG. 1, the lower moulded component 4, an embossing ring 13 is formed, which runs coaxially with the axis of the punched hole and is introduced during the punching process by a cut-emboss die. The punching, stamping rivet 6 preferably consists of a metallic material such as steel, or a non-metallic material such as an oxide ceramic. It has a head 14 and a shank 16.

The head 14 is designed as a countersunk head with a conical taper 18, as viewed in the punching direction. Alternatively the head 14 is designed, for example, as a universal head.

The shaft 16 has a punching section 20, a locking section 22, and also, in the example of embodiment shown, a deforming section 24. In the design of the punching, stamping rivet 6 as a multi-region rivet the latter can have a multiplicity of deforming sections 24 spaced apart from one another in the punching direction. As viewed in the punching direction, the locking section 22 is arranged behind the punching section 20, and the deforming section 24 is arranged behind the locking section 22. The locking section 22 is therefore arranged between the punching section 20 and the deforming section 24, wherein the punching section 20, as viewed in the punching direction, is located in front of the locking section 22 and the deforming section 24 is located behind the locking section 22.

The punching section 20 serves to form the punched hole 8. It can, for example, be hardened by means of local heat treatment, and/or can have an axial cutting edge, not numbered. In the example of embodiment shown in FIG. 1 it has a cylindrical shape with a constant external diameter d1, and merges directly into the locking section 22. In an alternative example of embodiment, not shown, the punching section tapers in the form of a cone in the direction of the head 14.

The locking section 22 serves to accommodate material from the lower moulded component 4, and thus to lock the joint 1. For purposes of accommodating the squeezed material it has an annular groove 26 with a concave groove wall. It has a minimum external diameter, i.e. a core diameter, d2, and via an increase in diameter merges into the deforming section 24. Alternatively a multiplicity of parallel annular grooves 26 can be provided in the locking section 22. Likewise the locking section 22 can be provided with an external thread instead of the at least one annular groove 26.

The deforming section 24 serves to provide the cold deformation of the upper moulded component 2 in the region of the punched hole 8. It has a cylindrical shape with a constant external diameter d3 and merges directly into the comical taper 14 of the head 8. In accordance with the invention the external diameter d3 of the deforming section 24 is greater than the external diameter d1 of the punching section 20, so that the following relationship applies: d3>d1>d2. A desired measure for the press fit with which the punching, stamping rivet 6 is accommodated in the punched hole 6 in the region of its deforming section 24, can be set by means of an appropriately selected diameter ratio d1:d3. In particular the diameter ratio d1:d3 is based on the material of the moulded component 2 to be hardened in the region of the punched hole, and on the level of hardening required. The deforming section 24 preferably has an extent in the punching direction, i.e. an axial length, that is greater than the axial length of the punching section 20 and that of the locking section 22. The deforming section 24 advantageously has an axial length that approximately corresponds to the thickness of the upper moulded component 2 in the joint region, so that the upper moulded component is hardened over the whole of its punched hole region when the punching, stamping rivet 6 is driven in.

In an inventive method for the joining of at least two moulded components 2, 4 the latter are clamped between a hold-down device and a cut-emboss die. The punching, stamping rivet 6 is then driven by means of a rivet stamp through the moulded components 2, 4, as a result of which a punched hole 12 is formed. A so-called punching slug is ejected on the side of the die. The punching, stamping rivet 6 is driven through the moulded components 2, 4 to the extent that its head 14 terminates flush with the surface 10 of the moulded component 2. By virtue of the conical taper 18 the head 14 is thereby embossed into the surface of the upper moulded component 2.

At the same time the punched hole 8 is radially widened by means of the deforming section 24 in the region of the moulded component 2 in accordance with the diameter ratio d1:d3, and in this manner the moulded component 2 is subjected to strain hardening in the punched hole region. As shown in FIG. 1, in this example of embodiment, after the sinking of the head 14, the deforming section 24 extends into the punched hole region of the lower moulded component 4, so that this region of the lower moulded component 4 is also hardened by means of the deforming section. Moreover, at the same time the lower moulded component 4 is squeezed in the region of the punched hole 8 with the locking section 22, i.e. with the annular groove 26, and thus locks the punching, stamping rivet 6 in the punched hole 8.

The inventive radial widening is limited to the regions of the punched hole that are not subjected to any squeezing action, or embossing by the cut-emboss die. In the example of embodiment here shown, inventive radial widening is not at all intended in the embossing region, that is to say, in the region of the locking section 22, since on the one hand the pressing action, i.e. the embossing action, by this means would be made more difficult and on the other hand during the actual embossing action compressive stresses are introduced into the lower moulded component 4 in the punched hole region, which lead to strain hardening. The moulded components 2, 4 are strain hardened by a combination of the deforming section 24 and the embossing action in the region of the locking section 22 in a manner that is quasi-seamless over the whole length of the punched hole 8. In the embodiment of the inventive punching, stamping rivet 6 as a multi-region rivet with a multiplicity of locking sections 22 and deforming sections 24 arranged in an alternating manner behind one another in the punching direction, a punched hole region is firstly radially widened and then radially tapered, i.e. embossed, so that an embossing action can very well be undertaken on a punched hole region that has already previously been cold formed by means of a deforming section 24.

The inventive method, i.e. the setting of the inventive punching, stamping rivet 6, can be executed, i.e. can be undertaken, with the same tools as in conventional punching, stamping rivet processes. However the punching die must be matched to the external diameter d1 of the punching section 20, in order that the punching slug can be freely discharged on the side of the die.

Disclosed is a method for the joining of moulded components with a punching, stamping rivet, wherein a punched hole is radially widened in at least certain sections of the moulded components that are to be punched; also disclosed is a punching, stamping rivet, which has a deforming section that has a greater external diameter than a punching section.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE SYMBOLS

1 Joint

2 Moulded component

4 Moulded component

6 Punching, stamping rivet

8 Punched hole

10 Surface

12 Surface

13 embossing ring

14 Head

16 Shank

18 Conical taper

20 Punching section

22 Locking section

24 Deforming section

26 Annular groove

d1 Punching section external diameter

d2 Locking section external diameter

d3 Deforming section external diameter

1. A method for the joining of moulded components with a punching, stamping rivet, including the step of radially widening at least a certain section of a punched hole during a punching of the moulded components.

2. The method in accordance with claim 1, wherein the radial widening is limited to punched hole regions that are free from a radial squeezing action by the punching, stamping rivet.

3. A punching, stamping rivet for the joining of moulded components, for use in a method in accordance with claim 1, comprising
a rivet head and at least one rivet shank having a punching section,
the rivet shank having at least one deforming section for widening a punched hole in at least a certain sections
the deforming section, as viewed in the punching direction, being arranged behind the punching section, and having a larger external diameter than the punching section.

4. The punching, stamping rivet in accordance with claim 3, wherein the at least one deforming section, as viewed in the punching direction, is arranged behind a locking section.

5. The punching, stamping rivet in accordance with claim 4, wherein the at least one deforming section extends from the punching section.

6. The punching, stamping rivet in accordance with claim 4, wherein the at least one deforming section extends as far as the rivet head.

7. The punching, stamping rivet in accordance with claim 4, wherein the external diameter of the at least one deforming section is constant.

8. The punching, stamping rivet in accordance with claim 4, wherein the at least one deforming section is radially widened in the direction of the rivet head.

9. The punching, stamping rivet in accordance with claim 7, wherein the at least one deforming section, as viewed in the punching direction, has a conical section, and, located behind that, a cylindrical section.

10. The punching, stamping rivet in accordance with claim 3, wherein the punching, stamping rivet is a multi-region rivet with deforming sections arranged between the locking sections.

11. A punching, stamping rivet for the joining of moulded components, comprising:
a rivet head and at least one rivet shank having a punching section,
the rivet shank having at least one deforming section for widening a punched hole in at least a certain sections
the deforming section, as viewed in the punching direction, being arranged behind the punching section, and having a larger external diameter than the punching section.
